(19) United States
(12) Patent Application Publication
(10) Pub. No.: US 2024/0403029 A1
(43) Pub. Date: Dec. 5, 2024

(54) DISPLAY CONTROL SYSTEM, DISPLAY CONTROL METHOD, AND INFORMATION STORAGE MEDIUM

(71) Applicant: Cybozu, Inc., Tokyo (JP)

(72) Inventors: Yuta SAITO, Saitama-shi (JP); Haruka KUNIHIRO, Tokyo (JP); Kensuke HAYASHI, Matsuyama-shi (JP); Hiroya NAGAO, Tokyo (JP)

(21) Appl. No.: 18/733,762

(22) Filed: Jun. 4, 2024

(30) Foreign Application Priority Data
Jun. 5, 2023 (JP) 2023-092415

(51) Int. Cl. G06F 8/65; G06F 9/451

(52) U.S. Cl. CPC G06F 8/65; G06F 9/451

(57) ABSTRACT

Provided is a display control system including at least one processor configured to: update, based on an update operation executed by a user who uses groupware, app setting data indicating a setting of an app of the groupware; save, in a data storage module, update location data indicating an update location of the app setting data when the app setting data is updated; and display, based on the update location data, the update location on an update location screen of the groupware.

### CROSS-REFERENCE TO RELATED APPLICATION

The present disclosure contains subject matter related to that disclosed in Japanese Patent Application JP 2023-092415 filed in the Japan Patent Office on Jun. 5, 2023 the entire contents of which are hereby incorporated by reference.

### BACKGROUND OF THE INVENTION

### 1. Field of the Invention

The present disclosure relates to a display control system, a display control method, and an information storage medium.

### 2. Description of the Related Art

Hitherto, there has been known groupware which supports a task in an organization. For example, in Japanese Patent Application Laid-open No. 2023-023848, there is described a system for updating app setting data indicating settings of an app of groupware of a cloud type based on an update operation executed by a user who uses the groupware.

For example, when a defect occurs in the app after the app setting data is updated, a user reviews the app setting data, to thereby execute troubleshooting. With the related art, update location data indicating update locations of the app setting data are not saved, and hence the user is required to recall the update locations of the app setting data. Thus, the related art cannot sufficiently increase convenience of the user. This point applies to other scenes in which the user is required to recall the update locations of the app setting data.

### SUMMARY OF THE INVENTION

One object of the present disclosure is to increase convenience of a user who uses groupware.

According to at least one embodiment of the present disclosure, there is provided a display control system including at least one processor configured to: update, based on an update operation executed by a user who uses groupware, app setting data indicating a setting of an app of the groupware; save, in a data storage module, update location data indicating an update location of the app setting data when the app setting data is updated; and display, based on the update location data, the update location on an update location screen of the groupware.

### BRIEF DESCRIPTION OF THE DRAWINGS

FIG. 1 is a diagram for illustrating an example of a hardware configuration of a display control system.

FIG. 2 is a view for illustrating an example of screens displayed on a display unit when a user uses groupware.

FIG. 3 is a view for illustrating an example of a setting update screen.

FIG. 4 is a view for illustrating an example of an update location screen.

FIG. 5 is a diagram for illustrating an example of functions implemented in the display control system.

FIG. 6 is a table for showing an example of an app database.

FIG. 7 is a diagram for illustrating an example of processing executed in the display control system.

FIG. 8 is a diagram for illustrating the example of the processing executed in the display control system.

FIG. 9 is a diagram for illustrating an example of functions implemented in a display control system of modification examples.

FIG. 10 is a view for illustrating an example of a restoration screen displayed on the display unit when the user has executed a restoration operation.

FIG. 11 is a view for illustrating an example of the restoration screen in Modification Example 2.

FIG. 12 is a view for illustrating an example of an another-app screen.

FIG. 13 is a view for illustrating an example of an influence screen.

FIG. 14 is a view for illustrating an example of the update location screen in Modification Example 5.

FIG. 15 is a view for illustrating an example of the setting update screen at the time when simultaneous update processing is executed.

FIG. 16 is a view for illustrating an example of a range screen.

### DETAILED DESCRIPTION OF THE INVENTION

### 1. Hardware Configuration of Display Control System

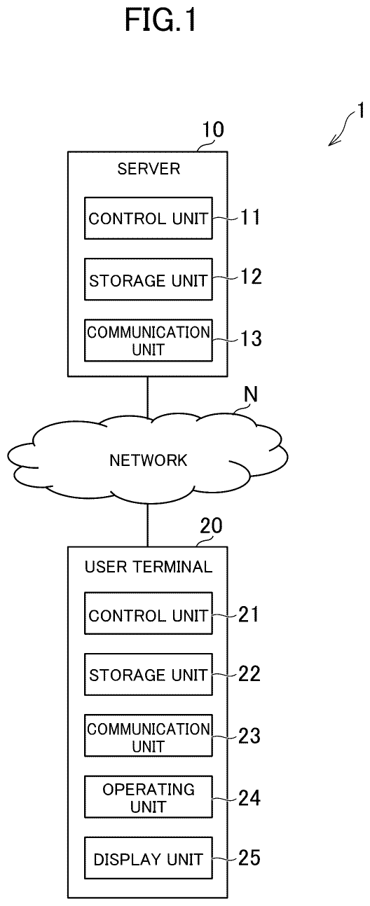

An example of a display control system according to at least one embodiment of the present disclosure is described. FIG. 1 is a diagram for illustrating an example of a hardware configuration of the display control system. For example, a display control system 1 includes a server 10 and a user terminal 20. The server 10 and the user terminal 20 are each connected to a network N, such as the Internet or a LAN.

The server 10 is a server computer. For example, the server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The user terminal 20 is a computer to be operated by a user who uses groupware. The groupware is software which supports a task in an organization. The groupware may be groupware of any one of a cloud type or an on-premises type. In the at least one embodiment, a company for which the user works has a contract for the groupware. In FIG. 1, only one user terminal 20 is illustrated, but the display control system 1 may include a plurality of user terminals 20.

For example, the user terminal 20 is a personal computer, a tablet terminal, or a smartphone. For example, the user terminal 20 includes a control unit 21, a storage unit 22, a communication unit 23, an operating unit 24, and a display unit 25. Hardware configurations of the control unit 21, the storage unit 22, and the communication unit 23 may be the same as those of the control unit 11, the storage e unit 12, and the communication unit 13, respectively. The operating unit 24 is an input device, such as a mouse, a touch panel, or a keyboard. The display unit 25 is a liquid crystal display or an organic EL display.

Programs stored in the storage units 12 and 22 may be supplied to the server 10 and the user terminal 20, respectively, via the network N. Moreover, a hardware configuration of each of the server 10 and the user terminal 20 is not limited to the example of FIG. 1. For example, a reading unit (for example, a memory card slot) which reads an information storage medium or an input/output unit (for example, a USB terminal) which is used to connect to the information storage medium may be included in each of the server 10 and the user terminal 20. In this case, programs stored in the information storage medium may be supplied to each of the server 10 and the user terminal 20 via the reading unit or the input/output unit.

Moreover, the display control system 1 is only required to include at least one computer. The computers included in the display control system 1 are not limited to the example of FIG. 1. For example, the display control system 1 may not include the user terminal 20. In this case, the user terminal 20 exists outside the display control system 1, and the display control system 1 includes only the server 10. The display control system 1 may include the server 10 and another server computer. The display control system 1 may include only a computer other than the server computer.

### 2. Overview of Display Control System

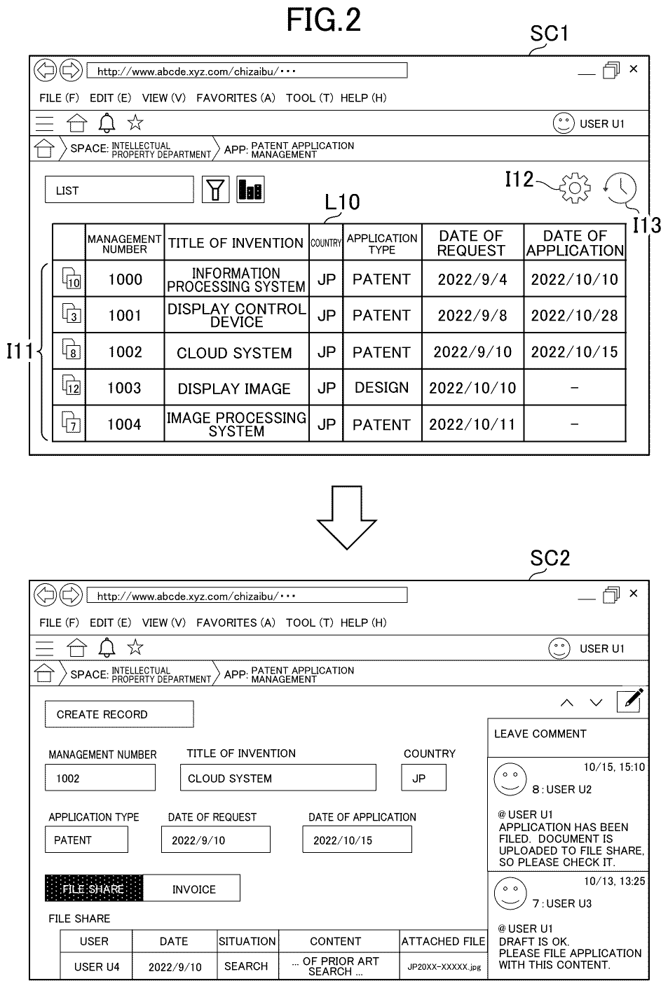

FIG. 2 is a view for illustrating an example of screens displayed on the display unit 25 when the user uses the groupware. In the example of FIG. 2, screens of an app which is a type of a database are illustrated. The app can be considered as a system or a tool which supports the task of the user. For example, the app includes at least one record forming the database. The app includes not only the database, but also a program for the user terminal 20 to execute predetermined processing.

For example, the user logs in to the groupware and selects any app. The user terminal 20 communicates to and from the server 10, and displays, on the display unit 25, a record list screen SC1 including a list L10 indicating a list of records of the app selected by the user. A first row of the list L10 indicates respective names of a plurality of fields. Each of the second and subsequent rows of the list L10 indicates respective values of the fields included in each record. An icon I11 for the user to check details of the record is displayed in the first column of each of the second and subsequent rows of the list L10.

For example, when the user selects the icon I11 on a certain row, the user terminal 20 communicates to and from the server 10, to thereby display, on the display unit 25, a record detail screen SC2 indicating details of a record corresponding to this row. The app in the at least one embodiment has not only a function as the database, but also has a function as a communication tool. For example, on the record detail screen SC2, not only the value of each field included in the record, but also content of comments included in the record is displayed.

In the at least one embodiment, a user having administrative authority of the app can update app setting data indicating settings of the app. For example, the app setting data includes setting items such as a name of the app, an icon of the app, a memo for the users having the administrative authority of the app, a layout of a form on the record detail screen SC2, a form of a graph displayed on the record detail screen SC2, a layout of the list L10 on the record list screen SC1, a notification condition method being a condition for notification to the user, a data type of the field, an access right of the app, and a name of a person in charge who uses the app. The setting items of the app setting data may be any setting items employed in publicly-known groupware.

In the description given below, it is assumed that the user has the administrative authority of the app. Only one user may have the administrative authority of the app, or each of a plurality of users may have the administrative authority of the app. For example, when the user selects an icon I12 of the record list screen SC1, the user terminal 20 communicates to and from the server 10, and displays a setting update screen for receiving an update operation described later on the display unit 25.

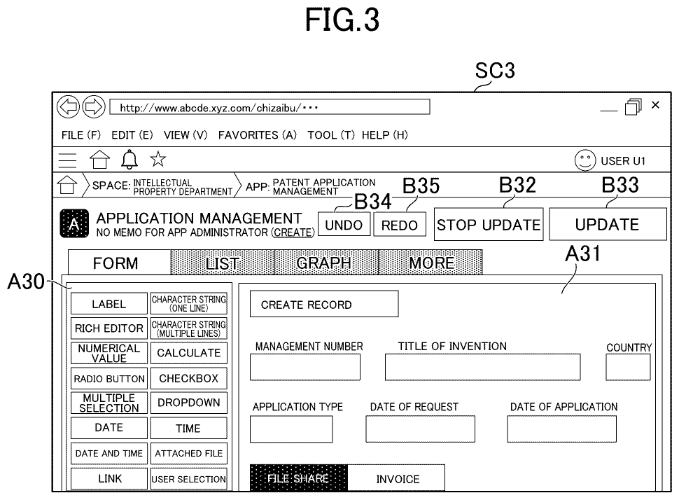

FIG. 3 is a view for illustrating an example of the setting update screen. For example, the user can specify setting content of a setting item “form” by dragging and dropping a box displayed in an area A30 of a setting update screen SC3 to an area A31. The setting content is a specific value of the setting item. In the example of FIG. 3, a title (name of the field) and a display position of each form on the record detail screen SC2 corresponds to the setting content of the setting item “form.” The user can specify, from the setting update screen SC3, setting content of another setting item other than the setting item “form.”

In the at least one embodiment, an operation in general executed from the setting update screen SC3 by the user is referred to as “update operation.” For example, an operation of the user for specifying the setting content of the setting item corresponds to the update operation. The dragging and dropping described above is an example of the update operation. The update operation may be any operation, and is not limited to the dragging and dropping. For example, an operation of the user for inputting a character string, an operation of the user for inputting a numerical value, an operation of the user for selecting a pulldown form, an operation of the user for selecting a checkbox, and other operations may correspond to the update operations.

For example, when the user selects a button B32, the update of the app setting data is stopped. When the user selects a button B33, the server 10 updates the app setting data. The operations of selecting the button B32 or B33 by the user may correspond to the update operations. The user can repeatedly update the app setting data. The server 10 saves update location data indicating an update location of the app setting data each time the server 10 updates the app setting data. The user can check the update location indicated by the update location data.

For example, when a defect occurs in the app after the app setting data has been updated, the user checks the update location of the app setting data in order to execute troubleshooting. The user can check the update location of the app setting data as the user himself or herself wishes also in a scene other than the scene of the execution of the troubleshooting, in principle. For example, when the user selects an icon I13 of the record list screen SC1, the user terminal 20 communicates to and from the server 10, and displays an update location screen indicating update locations of the app setting data on the display unit 25.

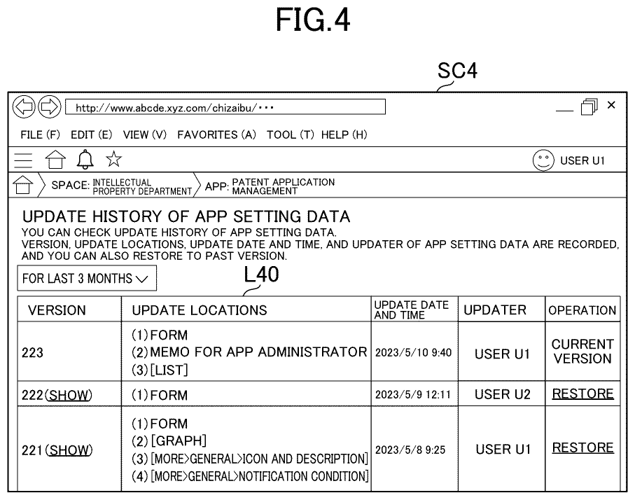

FIG. 4 is a view for illustrating an example of the update location screen. For example, the update location screen SC4 includes a list L40 indicating numerical values indicating versions of the app setting data (versions of the app), the update locations of the app setting data, update dates and times of the app setting data, and names of updaters of the app setting data. In the at least one embodiment, the version is “1” at a time immediately after the creation of the app. The version is incremented by one each time the app setting data is subsequently updated. In the example of FIG. 4, the current version is 223, and hence the app setting data has been updated 222 times.

For example, the first row of the list L40 indicates a header of the list L40. Each of the second and subsequent rows of the list L40 indicates information on the update locations and the like of each version. The second row is a row for a current version (latest version). The third and subsequent rows are rows for past versions. The pieces of information on the update locations and the like are arranged in descending order of the version from a top toward a bottom of the list L40. When the user selects “show” for a past version, details of the app setting data of this version are displayed on the update location screen SC4.

In the example of FIG. 4, as the update locations of the current version, a setting item “form,” a setting item “memo for app administrator,” and a setting item “list” are displayed. In the at least one embodiment, update locations are arranged in an order of the update operation of the user from the top toward the bottom on a row of a version including a plurality of update locations. In the example of FIG. 4, as a series of update operations at the time of the update of the app setting data to the current version, the user has executed the update operations in an order of specification of setting content of the setting item “form,” specification of setting content of the setting item “memo for app administrator,” and specification of setting content of the setting item “list.”

In the example of FIG. 4, a layout of the update locations in the row for each past version is similar to a layout of the update locations in the row for the current version. In the example of FIG. 4, as the update location of a version 222, the setting item “form” is displayed. As the update locations of a version 221, the setting item “form,” a setting item “graph,” a setting item “more>general>icon and description,” and a setting item “more>general>notification condition” are displayed. When the user scrolls the update location screen SC4, rows for further past versions are displayed on the update location screen SC4. For example, when a defect occurs in the app of the current version, the user examines whether or not to restore the app setting data to a past version. In the at least one embodiment, when the user selects a character string of “restore” of the list L40, the server 10 restores the app setting data such that the version returns to a version corresponding to the row on which this character string is arranged. The user may execute the troubleshooting by not selecting the character string of “restore” of the list L40, but by executing, after checking each piece of information such as the update location in the list L40, an update operation having the same flow as that of FIG. 3.

As described above, the display control system 1 displays the update locations of the app setting data on the update location screen SC4. With the update location screen SC4, the user is not required to recall the update locations of the app setting data in the past update, and hence the display control system 1 can increase convenience of the user. Further, the update location screen SC4 is displayed not as a screen at another place (for example, a domain of a certain company in a cooperative relationship with the provider of the groupware) other than the groupware, but as a screen on the groupware, and hence the user continues other work on the groupware after the user checks the update location screen SC4. Also in this respect, the display control system 1 can increase the convenience of the user.

For example, when the display function for the update locations of the app setting data is implemented by an external API cooperating with the groupware, the update locations of the app setting data are displayed by the external API. In this case, when the user is to update again the app setting data after the user checks the update locations of the app setting data, the user is required to select a URL or the like on the groupware side different from the screen of the external API side, and then log in to the groupware. In this respect, the display control system 1 displays the update locations of the app setting data on the update location screen SC4 of the groupware, and hence the user can remain in the groupware screen to execute the update work for the app setting data. Thus, the display control system 1 can save time and work of the user. Moreover, the external API is required to communicate to and from the server 10, to thereby display the update locations of the app setting data, but the display control system 1 does not require such communication. Thus, a processing load and a communication road can be reduced. Further, the provider of the groupware is not required to develop a function for cooperation with the external API, and hence a load on the provider of the groupware can also be reduced. The display control system 1 provides advantageous effects compared with the external API in those respects.

### 3. Functions Implemented in Display Control System

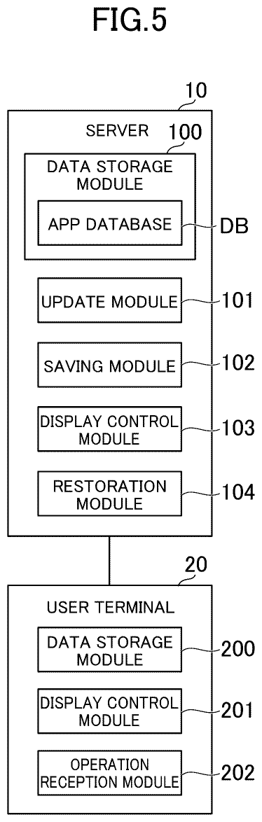

FIG. 5 is a diagram for illustrating an example of functions implemented in the display control system 1.

### [3-1. Functions Implemented in Server]

For example, the server 10 includes a data storage module 100, an update module 101, a saving module 102, a display control module 103, and a restoration module 104. The data storage module 100 is implemented by the storage unit 12. Each of the update module 101, the saving module 102, the display control module 103, and the restoration module 104 is implemented by the control unit 11.

### [Data Storage Module]

The data storage module 100 stores data required for the user to use the groupware. For example, the data storage module 100 stores an app database DB in which data on at least one app is stored.

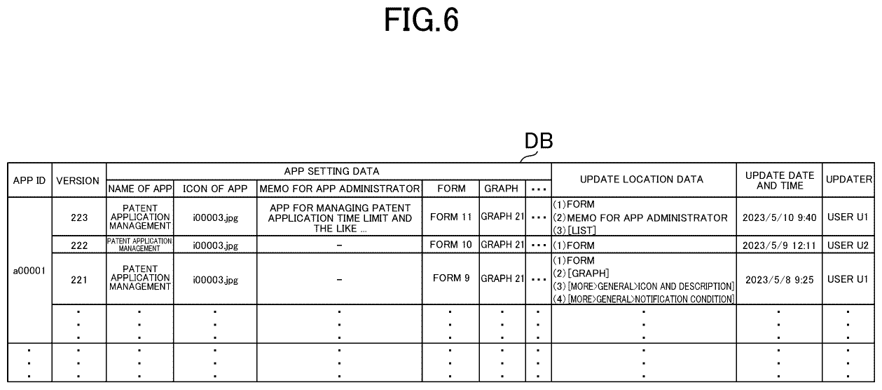

FIG. 6 is a table for showing an example of the app database DB. For example, character strings indicating an app ID used by each of the server 10 and the user terminal 20 to identify each app, the version of the app setting data, the app setting data, the update location data, update dates and times, and the names of the updaters are stored in the app database DB. In the app database DB, any data may be stored, and the data stored in the app database DB is not limited to the example of FIG. 6. For example, in the app database DB, record data indicating details of each record may be stored.

In the at least one embodiment, for each version, a dataset formed of the app setting data, the update location data, the update date and time, and the updater exists. The app setting data indicates specific setting content of each of a plurality of setting items. For example, the app setting data indicates, as the setting content of a setting item “name of app,” a character string input by the user. The app setting data indicates, as the setting content of the setting item “icon of app,” a file name of an image uploaded by the user. The app setting data indicates, as the setting content of the setting item “form,” an arrangement of each form and a title of each form. The same applies to other setting items, and the app setting data indicates the setting content of each of the other setting items.

For example, the update location data indicates at least one update location. The update location data for a certain version can be considered as a difference between the app setting data of this version and the app setting data of an immediate previous version of this version. When a plurality of update locations exist in the app setting data, the update location data indicates a chronological relationship among the plurality of update locations. For example, the update location data indicates a sequence of the plurality of update operations of the user. In the at least one embodiment, the update location data indicates details of a series of setting change operations executed by the user from the selection of the icon 112 of the record list screen SC1 by the user until the selection of the button B33 of the setting update screen SC3 by the user.

The data storage module 100 may store any data. The data stored in the data storage module 100 is not limited to the app database DB. For example, the data storage module 100 may store a database which stores a password and the like for the user to log in to the groupware or may store data on functions (such as a thread function, a schedule function, or a report creation function) other than the app.

### [Update Module]

The update module 101 updates, based on the update operation executed by the user who uses the groupware, the app setting data indicating the setting of the app of the groupware. In the at least one embodiment, the storage of the app setting data of the current version in the app database DB by the update module 101 corresponds to the update of the app setting data by the update module 101. When the app setting data of a past version is not stored in the app database DB, and only the app setting data of the current version is stored in the app database DB, overwrite of the app setting data of the current version by the update module 101 corresponds to the update of the app setting data by the update module 101.

For example, when the user executes the update operation on the setting update screen SC3, the user terminal 20 transmits, to the server 10, operation data indicating the update operation executed by the user. When the user executes a plurality of update operations, the operation data indicates a chronological relationship among the plurality of update operations. The server 10 receives the operation data from the user terminal 20. The update module 101 updates, based on the update operation indicated by the operation data, the app setting data such that the setting item selected by the user has the setting content specified by the user. When the user adds a setting item through the update operation, the update module 101 updates the app setting data such that the setting item specified by the user is added.

In the at least one embodiment, the version of the app setting data is managed in the app database DB, and hence the update module 101 increments the version of the app setting data. The update module 101 updates the app database DB so that the app ID, the version after the increment, and the app setting data after the update of the app for which the user has executed the update operation are associated with one another. The update module 101 also stores, in the app database DB, other data such as the update date and time and the updater.

### [Saving Module]

The saving module 102 saves, in the data storage module 100, the update location data indicating the update locations of the app setting data when the app setting data is updated. In the at least one embodiment, the saving module 102 saves the update location data in the app database DB. The saving module 102 may save the update location data in another database other than the app database DB. The saving module 102 may save the update location data in another computer other than the server 10 or an external information storage medium. That is, the data storage module 100 may be implemented by another computer or an external information storage medium.

For example, the saving module 102 identifies the update location of the app setting data based on the operation data received by the server 10 from the user terminal 20. In the at least one embodiment, the saving module 102 identifies, as the update location, the setting item selected by the user and the setting content of this setting item. The saving module 102 may identify, as the update location, only the setting item specified by the user. The saving module 102 generates the update location data indicating the identified update location, and saves the generated update location data in the data storage module 100. The saving module 102 may simply save the operation data received by the server 10 from the user terminal 20 as it is in the data storage module 100 as the update location data.

For example, when the saving module 102 identifies a plurality of update locations, the saving module 102 generates the update location data indicating each of the plurality of update locations. When a plurality of update locations exist in the app setting data, the update location data indicates the chronological relationship among the plurality of update locations. For example, the update location data indicates the sequence of update operations executed by the user, and corresponding to the plurality of update locations. The update location data may indicate a date and time of the update operation executed by the user. In this case, it is assumed that the data and time is indicated in the operation data. The saving module 102 saves the update location data in the app database DB such that the update location data is associated with the app ID and the current version of the app setting data for the app for which the user has executed the update operation.

### [Display Control Module]

The display control module 103 causes the user terminal 20 to display a screen of the groupware. The screen of the groupware is a screen displayed on a screen of a domain of the groupware or a program (for example, a smartphone app) dedicated to the groupware. In the at least one embodiment, the display control module 103 is included in the server 10, and hence the display control module 103 transmits display data on the screen to be displayed to the user terminal 20, to thereby cause the user terminal 20 to display this screen.

It is only required that the display data be data required by the user terminal 20 to display a certain screen on the display unit 25, and the display data may have any form. For example, when the user uses a browser, the display data may be HTML data. When the user uses not the browser, but a program dedicated to the groupware, data (for example, image data such as JPEG) having a form supported by this program is only required to be the display data.

For example, the display control module 103 displays, based on the update location data, the update location of the app setting data on the update location screen SC4 of the groupware. The display control module 103 displaying a character string, a numerical value, an icon, or another image indicating the update location of the app setting data on the update location screen SC4 corresponds to the display control module 103 displaying the update location of the app setting data on the update location screen SC4. In the example of FIG. 4, the display control module 103 also displays other information (for example, the version, the update date and time, and the updater) other than the update location of the app setting data on the update location screen SC4, but the display control module 103 may display only the update location of the app setting data on the update location screen SC4.

For example, when a plurality of update locations exist in the app setting data of a certain version, the display control module 103 displays the plurality of the update locations arranged in a chronological order (sorted in an order starting from the newest location or the oldest location) on the update location screen SC4. In the at least one embodiment, the display control module 103 displays such an update location screen SC4 that the update locations are arranged in the sequence of the update operation of the user from the top to the bottom of the update location screen SC4. The display control module 103 may arrange the plurality of update locations in a chronological order in another direction other than the direction from the top to the bottom. For example, the display control module 103 may arrange the plurality of update locations in a chronological order from the bottom to the top, the left to the right, or the right to the left.

In the example of FIG. 4, the app setting data of the version 223 has three update locations. The display control module 103 causes the user terminal 20 to display the update location screen SC4 such that the three update locations are arranged from the top to the bottom in the sequence of the update operation by the user in a row of the version 223 in the list L40. The app setting data of the version 221 has four update locations. The display control module 103 causes the user terminal 20 to display the update location screen SC4 such that the four update locations are arranged from the top to the bottom in the sequence of the update operation by the user in a row of the version 221 in the list L40.

### [Restoration Module]

The restoration module 104 restores the app setting data based on a restoration operation executed by the user on the update location screen SC4. In the at least one embodiment, the user selecting “restore” in the list L40 of the update location screen SC4 corresponds to the restoration operation. The restoration operation may be any other operation, and is not limited to the example in the at least one embodiment. For example, the restoration operation may be an operation of selecting a certain icon or button by the user.

For example, the restoration module 104 returning the app setting data to a past version corresponds to the restoration of the app setting data by the restoration module 104. In other words, the restoration module 104 returning the whole or a part of the app setting data of the current version to the whole or a part of the app setting data of a past version corresponds to the restoration of the app setting data by the restoration module 104. In the at least one embodiment, among pieces of the app setting data stored in the app database DB, pieces of the app setting data that have versions older than the current version correspond to past versions.

For example, when the restoration module 104 restores the app setting data, the restoration module 104 increments the current version. The update module 101 updates the app database DB such that the app ID of the app having the app setting data to be restored, the version after the increment, the app setting data after the restoration, the update date and time, and the updater are associated with one another. When the app setting data is to be restored, the update location data is not required to be stored in the app database DB. In the at least one embodiment, the app setting data after the restoration is the same as the past app setting data selected by the user through the restoration operation. As in a modification example described later, a part of the app setting data after the restoration and a part of the past app setting data selected by the user may be different from each other.

### [3-2. Functions Implemented in User Terminal]

For example, the user terminal 20 includes a data storage module 200, a display control module 201, and an operation reception module 202. The data storage module 200 is implemented by the storage unit 22. The display control module 201 and the operation reception module 202 are implemented by the control unit 21.

### [Data Storage Module]

The data storage module 200 stores data required for the user to use the groupware. For example, the data storage module 200 stores the browser. For example, the data storage module 200 stores a program dedicated to the groupware.

### [Display Control Module]

The display control module 201 displays a screen in the groupware on the display unit 25. The display control module 201 displays the screen in the groupware on the display unit 25 based on display data on the screen to be displayed, which is received from the server 10. For example, the display control module 201 displays the update location screen SC4 on the display unit 25 based on display data on the update location screen SC4, which is received from the server 10.

### [Operation Reception Module]

The operation reception module 202 receives the operation on the screen of the groupware. The operation reception module 202 transmits, to the server 10, the operation data indicating an operation executed by the user. For example, the operation reception module 202 transmits, to the server 10, the operation data indicating the content of the update operation executed by the user.

### 4. Processing Executed in Display Control System

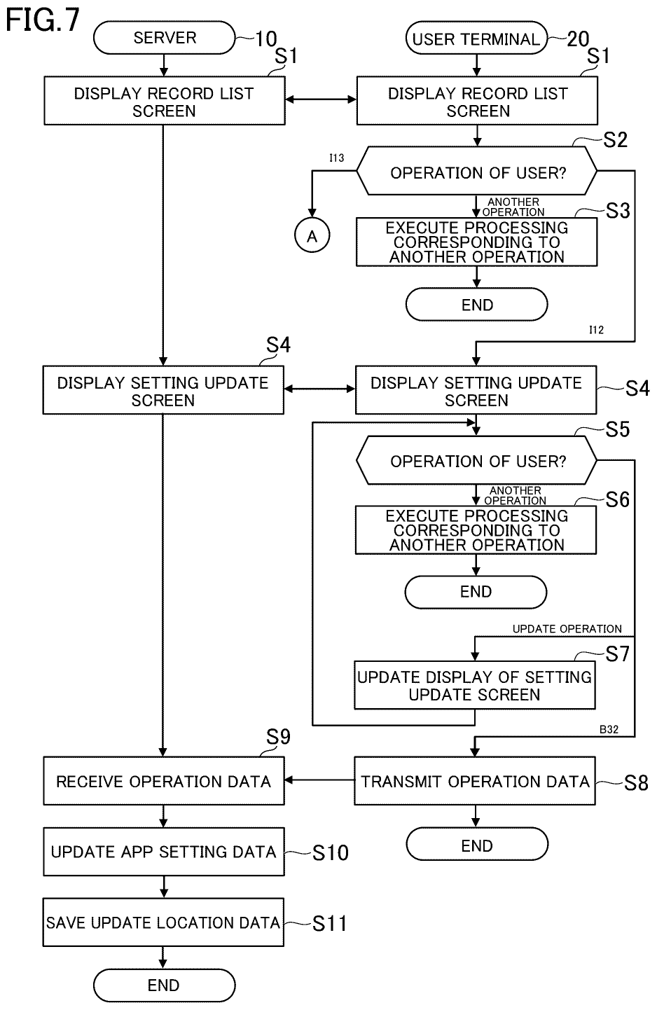

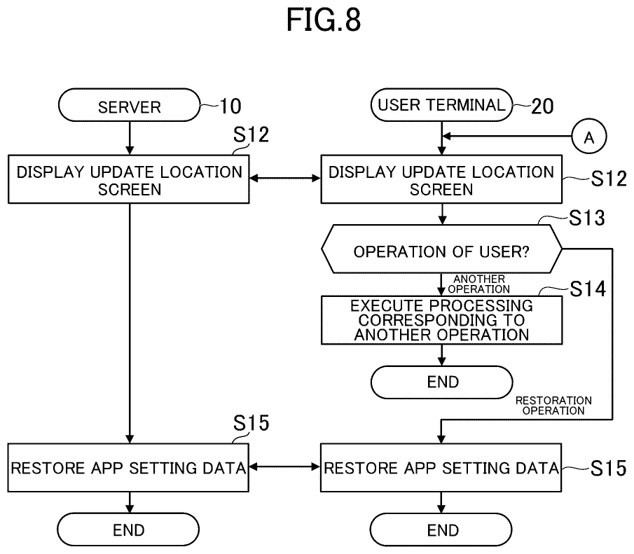

FIG. 7 and FIG. 8 are flowcharts for illustrating an example of processing executed in the display control system 1. The processes of FIG. 7 and FIG. 8 are executed by the control units 11 and 21 executing the programs stored in the storage units 12 and 22, respectively. In FIG. 7 and FIG. 8, processing executed when the user logs in to the groupware and selects an app is illustrated. It is assumed that the server 10 has identified, in advance, an app ID of the app being a processing target of FIG. 7 and FIG. 8.

For example, the user terminal 20 executes, between the user terminal 20 and the server 10, processing for displaying the record list screen SC1 on the display unit 25 (Step S1). In Step S1, the user terminal 20 transmits a display request for the record list screen SC1 to the server 10. When the server 10 receives the display request from the user terminal 20, the server 10 generates the display data on the record list screen SC1 based on the app database DB, and transmits the display data to the user terminal 20. When the user terminal 20 receives the display data on the record list screen SC1, the user terminal 20 displays the record list screen SC1 on the display unit 25.

The user terminal 20 identifies the operation of the user on the record list screen SC1 based on a signal detected by the operating unit 24 (Step S2). In Step S2, it is assumed that an operation of selecting the icon 112 by the user, an operation of selecting the icon I13 by the user, or another operation is executed. When another operation is executed in Step S2 (“another operation” in Step S2), the user terminal 20 executes processing corresponding to this another operation (Step S3), and the processing of FIG. 7 and FIG. 8 is finished.

When the user selects the icon 112 in Step S2 (“I12” in Step S2), the user terminal 20 executes, between the user terminal 20 and the server 10, processing for displaying the setting update screen SC3 on the display unit 25 (Step S4). In Step S4, the user terminal 20 transmits a display request for the setting update screen SC3 to the server 10. When the server 10 receives the display request from the user terminal 20, the server 10 generates the display data on the setting update screen SC3 based on the app database DB, and transmits the display data to the user terminal 20. When the user terminal 20 receives the display data on the setting update screen SC3, the user terminal 20 displays the setting update screen SC3 on the display unit 25.

The user terminal 20 identifies the operation of the user on the setting update screen SC3 based on the signal detected by the operating unit 24 (Step S5). In Step S5, it is assumed that the update operation, the operation of selecting the button B32 by the user, or another operation is executed. When another operation is executed in Step S5 (“another operation” in Step S5), the user terminal 20 executes processing corresponding to this another operation (Step S6), and the processing of FIG. 7 and FIG. 8 is finished.

When the user executes the update operation in Step S5 (“update operation” in Step S5), the user terminal 20 updates the display of the setting update screen SC3 (Step S7), and the process returns to Step S5. In Step S7, the user terminal 20 records, in the storage unit 12, operation data indicating the update operation executed by the user. When the user selects the button B32 in Step S5 (“B32” in Step S5), the user terminal 20 transmits, to the server 10, the operation data indicating the update operation (Step S8).

When the server 10 receives the operation data from the user terminal 20 (Step S9), the server 10 updates the app setting data based on the update operation indicated by the operation data (Step S10). In Step S10, the server 10 increments the version of the app setting data. The server 10 updates the app database DB such that the app ID, the version after the increment, the app setting data after the update, the update date and time, and the updater are associated with one another. The server 10 saves the update location data on the app setting data in the app database DB (Step S11), and the processing of FIG. 7 and FIG. 8 is finished.

In Step S2, when the user selects the icon I13 (“I13” in Step S2), the process proceeds to FIG. 8, and the user terminal 20 executes, between the user terminal 20 and the server 10, the processing for displaying the update location screen SC4 on the display unit 25 (Step S12). In Step S12, the user terminal 20 transmits the display request for the update location screen SC4 to the server 10. When the server 10 receives the display request from the user terminal 20, the server 10 generates the display data on the update location screen SC4 based on the app database DB, and transmits the display data to the user terminal 20. When the user terminal 20 receives the display data on the update location screen SC4, the user terminal 20 displays the update location screen SC4 on the display unit 25.

The user terminal 20 identifies the operation of the user on the update location screen SC4 based on the signal detected by the operating unit 24 (Step S13). In Step S13, the restoration operation or another operation is executed. When another operation is executed in Step S13 (“another operation” in Step S13), the user terminal 20 executes processing corresponding to this another operation (Step S14), and the processing of FIG. 7 and FIG. 8 is finished.

When the user selects the restoration operation in Step S13 (“restoration operation” in Step S13), the user terminal 20 executes, between the user terminal 20 and the server 10, the processing for restoring the app setting data (Step S15), and the processing of FIG. 7 and FIG. 8 is finished. In Step S15, the user terminal 20 requests the server 10 to restore the app setting data. When the server 10 receives the request from the user terminal 20, the server 10 restores the app setting data.

The display control system 1 according to the at least one embodiment updates the app setting data based on the update operation executed by the user. The display control system 1 saves the update location data in the storage unit 12 when the app setting data is updated. The display control system 1 displays, based on the update location data, the update location of the app setting data on the update location screen SC4 of the groupware. The user can easily recognize the update location of the app setting data through use of the update location screen SC4, and hence the display control system 1 can increase the convenience of the user. For example, when a defect occurs in the app, the user can check the update location of the app setting data on the update location screen SC4 to execute troubleshooting. Even when a defect does not occur in the app, but when the user wants to check the update location of the app setting data for some reason, the display control system 1 can increase the convenience of the user. The update location screen SC4 is displayed as the screen on the groupware. Thus, after the user checks the update location screen SC4, the user can remain in the groupware to execute another operation. Also in this respect, the display control system 1 can increase the convenience of the user.

Moreover, when a plurality of update locations exist in the app setting data, the update location data indicates the chronological relationship among the plurality of update locations. The display control system 1 displays, on the update location screen SC4, the plurality of update locations arranged in a chronological order. The update location screen SC4 promotes the user's intuitive recognition of the chronological relationship among the plurality of update locations, and hence the display control system 1 can further increase the convenience of the user. For example, when a defect occurs in the app, the user may execute the troubleshooting while recalling a chronological flow of the update operation at the time of the update of the app setting data. In this case, the update location screen SC4 promotes the troubleshooting by the user.

Moreover, the display control system 1 restores the app setting data based on the restoration operation executed by the user on the update location screen SC4 and the past data. The user can easily return the app setting data to a past version through the restoration of the app setting data, and hence the display control system 1 can increase the convenience of the user. For example, it is not required for the user to execute such work as opening the app setting data of the latest version on the update location screen SC4 and inputting past setting content, and hence the display control system 1 can reduce a load on the user.

### 5. Modification Examples

The present disclosure is not limited to the example of the at least one embodiment. The present disclosure can be modified without departing from the purport of the present disclosure.

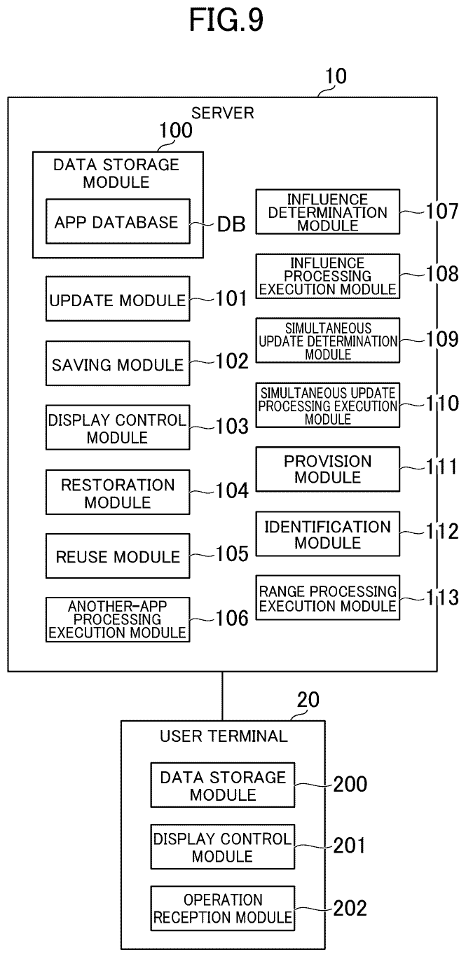

FIG. 9 is a diagram for illustrating an example of functions implemented in the display control system 1 according to modification examples. As illustrated in FIG. 9, the server 10 in the modification examples includes a reuse module 105, an another-app processing execution module 106, an influence determination module 107, an influence processing execution module 108, a simultaneous update determination module 109, a simultaneous update processing execution module 110, a provision module 111, an identification module 112, and a range processing execution module 113. Each of the reuse module 105, the another-app processing execution module 106, the influence determination module 107, the influence processing execution module 108, the simultaneous update determination module 109, the simultaneous update processing execution module 110, the provision module 111, the identification module 112, and the range processing execution module 113 is implemented by the control unit 11.

### 5-1. Modification Example 1

For example, when the user executes the restoration operation, the user sometimes wants to execute at least one of change, cancel, or addition of an update location on a past version of the app setting data. Thus, the display control system 1 according to Modification Example 1 does not simply restore the app setting data to the past version, but restores the app setting data such that at least one of the change, the cancel, or the addition of the update location is executed.

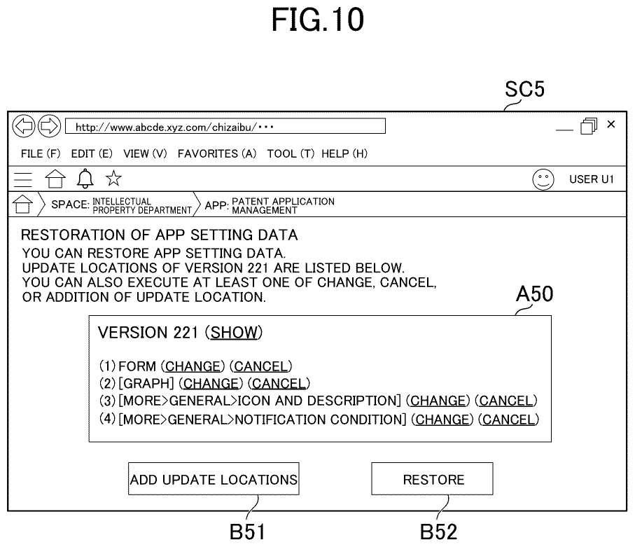

FIG. 10 is a view for illustrating an example of a restoration screen displayed on the display unit 25 when the user has executed the restoration operation. For example, when the user selects “restore” of the version 221 on the update location screen SC4, the display control module 103 causes the user terminal 20 to display a restoration screen SC5 including an area A50 indicating the update locations of the version 221 selected by the user. The user can execute at least one of the change, the cancel, or the addition of the update location from the restoration screen SC5. The restoration screen SC5 is not required to receive all of those three operations and may receive only one or two of those operations.

For example, selection of “change” of the update location displayed in the area A50 by the user corresponds to the operation of the change of the update location. Selection of “cancel” of the update location displayed in the area A50 by the user corresponds to the operation of the cancel of the update location. Selection of a button B51 by the user corresponds to an operation of the addition of the update location. When the user selects the button B51, the display control module 103 causes the user terminal 20 to display a screen similar to the setting update screen SC3. The user specifies the update location to be added from this screen.

The restoration module 104 in Modification Example 1 restores the app setting data such that at least one of the change, the cancel, and the addition of the update location is executed on the past app setting data. For example, the restoration module 104 restores the app setting data such that the setting content of the update location of the past app setting data that is selected by the user is changed. The restoration module 104 restores the app setting data such that the setting content of the past app setting data is not changed at each update location that is not selected by the user, and the setting content of the past app setting data is changed at each update location that is selected by the user.

For example, when the user selects “change” of the setting item “graph” displayed in the area A50, the restoration module 104 does not make a change from the setting content of the version 221 for the setting item “form,” the setting item “more>general>icon and description,” and the setting item “more>general>notification condition.” The restoration module 104 makes a change, for the setting item “graph,” to new setting content specified by the user on the restoration screen SC5 or another screen. The restoration module 104 stores this changed app setting data in the app database DB as the app setting data of a version 224.

For example, when the user selects “cancel” of the setting item “graph” displayed in the area A50, the restoration module 104 restores the app setting data such that the update of the setting item “graph” is canceled (the update of the setting item “graph” is not executed). The restoration module 104 does not make a change from the setting content of the version 221 for the setting item “form,” the setting item “more>general>icon and description,” and the setting item “more>general>notification condition.”

For example, when the user selects the button B51 and specifies a new update location, the restoration module 104 restores the app setting data such that the update location specified by the user is added. In the example of FIG. 10, when the user specifies the setting content of the setting item “memo for app administrator” as the fifth update location, the restoration module 104 restores the app setting data such that the fifth update location is added to the four update locations of the version 221.

The display control system 1 according to Modification Example 1 restores the app setting data such that at least one of the change, the cancel, and the addition of the update location is executed on the past app setting data. The display control system 1 does not simply restore the app setting data to the past app setting data, but can execute the restoration convenient for the user to use, and hence can further increase the convenience of the user.

### 5-2. Modification Example 2

For example, the user sometimes wants to return the app setting data to that at a time when the update operation for some of the setting items of a past version was executed. In the example of FIG. 4, the user executed four update operations when the app setting data was updated to the version 221. The user sometimes wants to restore the app setting data to that at the time of the third update operation (operation of specifying the setting content of the setting item “graph” by the user) of the four update operations. That is, the user sometimes wants to discard the fourth update operation of the app setting data of the version 221. Thus, the display control system 1 according to Modification Example 2 is capable of restoring the app setting data to that at a time corresponding to the update location selected by the user.

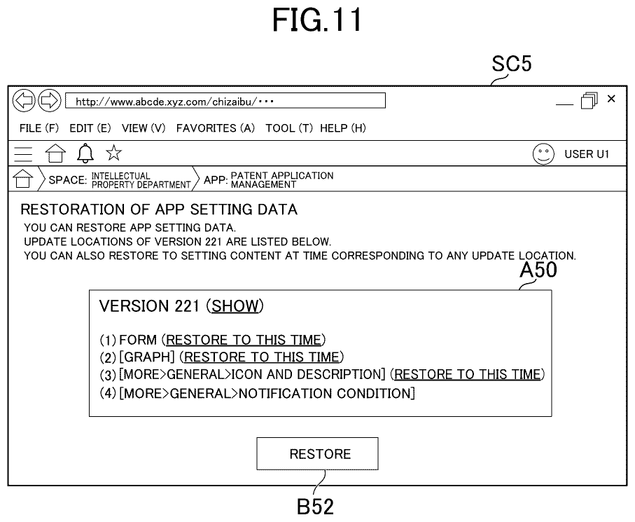

FIG. 11 is a view for illustrating an example of the restoration screen SC5 in Modification Example 2. The restoration screen SC5 in Modification Example 2 is similar to the restoration screen SC5 in Modification Example 1, but is different in that the user can select a time to which the user wants to restore the app setting data. For example, when the user wants to restore the setting content of the setting item “graph” to the app setting data at a specified time, the user selects “restore to this time” of the setting item “graph” displayed in the area A50. In the example of FIG. 11, the setting content at the time of the fourth update location “more>general>notification condition” is the same as that of the version 221, and hence the message “restore to this time” is not displayed.

When a plurality of update locations exist in past app setting data, the restoration module 104 in Modification Example 2 restores the app setting data based on the setting content at the time corresponding to an update location that is selected by the user among the plurality of update locations. The restoration module 104 restores the app setting data such that the latest app setting data is restored to the app setting data at the time corresponding to the update location selected by the user. The restoration module 104 cancels the update locations after the time corresponding to the update location that is selected by the user among the plurality of update locations in the past app setting data.

In the example of FIG. 11, when the user selects “restore to this time” of the setting item “graph” displayed in the area A50, the setting content is not changed from that of the version 221 for the setting item “form” and the setting item “graph.” The restoration module 104 cancels the setting content of the version 221 for the setting item “more>general>icon and description” and the setting item “more>general>notification condition.” The version of the app setting data restored by the restoration module 104 is 224.

When a plurality of update locations exist in past app setting data, the display control system 1 according to Modification Example 2 restores the app setting data based on the setting content at the time corresponding to the update location that is selected by the user among the plurality of update locations. The user does not simply return the app setting data to past app setting data, but can return to that at a desired time, and hence the display control system 1 can further increase the convenience of the user.

### 5-3. Modification Example 3

For example, in the groupware, the app setting data for a certain app may be reused for another app. In Modification Example 3, it is assumed that, after the user creates the app “patent application management” described in the at least one embodiment, the user creates another app “pension management” for which the app setting data for the app “patent application management” is reused. The whole or a part of the app setting data for the another app “pension management” is the same as the app setting data for the app “patent application management.”

The display control system 1 according to Modification Example 3 includes the reuse module 105 and the another-app processing execution module 106. The reuse module 105 reuses the app setting data for the another app “pension management” different from the app “patent application management.” The reuse module 105 copies the whole or a part of the app setting data for the app “patent application management,” to thereby create the app setting data for the app “pension management.” The app setting data for the app “patent application management” and the app setting data for the app “pension management” are pieces of data independent of each other, and hence the user can update those pieces of the app setting data independently. The reuse module 105 saves data indicating a relationship between apps between which the app setting data is reused in the app database DB or another database. The server 10 can identify an app having the app setting data reused for another app based on this data.

The another-app processing execution module 106 executes predetermined another-app processing when the app setting data for the app “patent application management” reused for the another app “pension management” has been restored. The another-app processing is only required to be certain processing relating to the another app “pension management,” and processing of prompting the user to review the app setting data for the another app “pension management” corresponds to the another-app processing in Modification Example 3. For example, the another-app processing execution module 106 causes the user terminal 20 to display an another-app screen which prompts the review of the app setting data for the another app “pension management” when the app setting data for the app “patent application management” is restored.

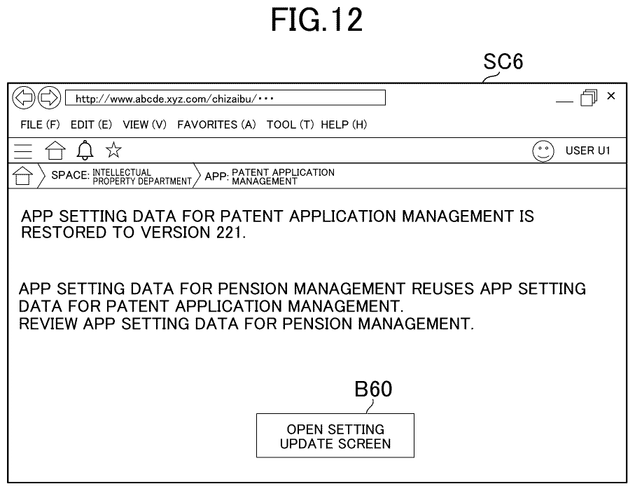

FIG. 12 is a view for illustrating an example of the another-app screen. For example, the another-app processing execution module 106 causes the user terminal 20 to display an another-app screen SC6 including such a message as “Review app setting data for pension management.” when the app setting data for the app “patent application management” is restored. The another-app processing execution module 106 transmits display data on the another-app screen SC6 to the user terminal 20, to thereby cause the user terminal 20 to display the another-app screen SC6. When the user selects a button B60 of the another-app screen SC6, the display control module 103 causes the user terminal 20 to display the setting update screen SC3 for the app “pension management.”

The another-app processing may be other processing. For example, the another-app processing execution module 106 may reuse, as the another-app processing, for the another app “pension management,” the app setting data for the app “patent application management” after the restoration. In this case, the app setting data for the another app “pension management” has the same setting content as that of the app setting data for the app “patent application management” after the restoration. The another-app processing execution module 106 may not simply reuse the app setting data for the app “patent application management” after the restoration for the another app “pension management,” but may change the setting content of the setting item selected by the user, and then reuse the changed app setting data for the another app “pension management.”

The display control system 1 according to Modification Example 3 reuses the app setting data for the another app “pension management” different from the app “patent application management.” The display control system 1 executes the another-app processing when the app setting data for the app “patent application management” reused for the another app “pension management” is restored, and hence can further increase the convenience of the user. For example, the display control system 1 can cause the user terminal 20 to display the another-app screen SC6 to prompt the user to review the app setting data for the another app “pension management.” For example, the display control system 1 can reuse the app setting data for the app “patent application management” after the restoration for the another app “pension management” to eliminate necessity for an update operation by the user for the app setting data for the another app “pension management.”

### 5-4. Modification Example 4

For example, a setting item influenced by the update or the restoration of the app setting data may exist in the setting items of the app setting data. In Modification Example 4, a setting item “access right” indicating an access right to the app and a setting item “person in charge” indicating a person in charge of a task relating to the app are exemplified. It is assumed that, after the user specifies setting content of the setting item “access right” and the setting item “person in change” and updates the app setting data, the user deletes a specific person in charge in the setting item “person in charge.” In this case, it is sometimes better for the user to review the setting content of the setting item “access right.” Thus, in this case, the display control system 1 according to Modification Example 4 prompts the user to review the setting content of the setting item “access right.”

The display control system 1 according to Modification Example 4 includes the influence determination module 107 and the influence processing execution module 108. The influence determination module 107 determines, based on relationship data indicating a relationship between the setting items of the app setting data, whether or not a setting item influenced by the update of the app setting data exists. The data storage module 100 in Modification Example 4 stores the relationship data. The relationship data may be in any form, and may be, for example, in a table form, a part of a program, in a mathematical expression form, or a model of machine learning.

For example, the relationship data may be prepared by the provider of the groupware, or may be prepared by the user. In the relationship plurality of setting items are associated with each other. For example, it is indicated in the relationship data that the setting item “access right” and the setting item “person in charge” relate to each other. Moreover, for example, it is indicated in the relationship data that the setting item “more>general>notification condition” and the setting item “person in charge” relate to each other.

For example, when a certain setting item is updated, the influence determination module 107 determines whether or not another setting item associated with this setting item exists based on the relationship data. The influence determination module 107 determines that no setting item influenced by the update of the app setting data exists when another setting item does not exist. The influence determination module 107 determines that a setting item influenced by the update of the app setting data exists when another setting item exists.

The influence processing execution module 108 executes predetermined influence processing based on a determination result obtained by the influence determination module 107. It is only required that the influence processing be certain processing relating to the setting item influenced by the update of the app setting data. In Modification Example 4, processing of prompting the user to review the setting item influenced by the update of the app setting data corresponds to the influence processing. For example, the influence processing execution module 108 causes the user terminal 20 to display an influence screen which prompts the user to review the setting item “access right” when the setting content of the setting item “person in charge” is updated.

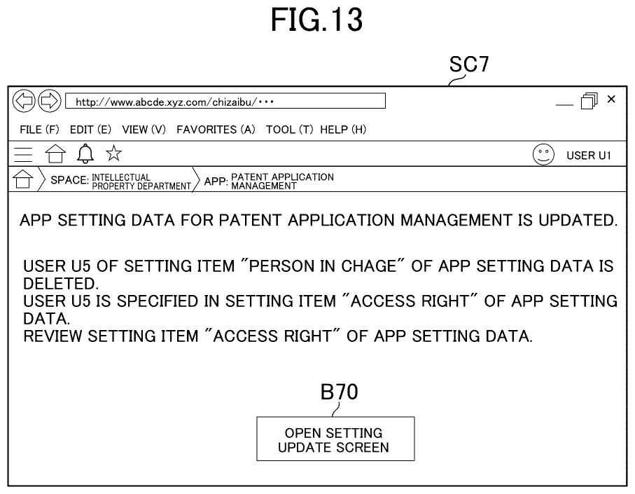

FIG. 13 is a view for illustrating an example of the influence screen. For example, the influence processing execution module 108 causes the user terminal 20 to display an influence screen SC7 which includes a message “Review the setting item ‘access right’ of the app setting data.” when the setting content of the setting item “person in charge” is updated. The influence processing execution module 108 transmits display data on the influence screen SC7 to the user terminal 20, to thereby cause the user terminal 20 to display the influence screen SC7. When the user selects a button B70 of the influence screen SC7, the display control module 103 causes the user terminal 20 to display the setting update screen SC3 of the app “patent application management.”

The influence processing may be other processing. For example, the influence processing execution module 108 may automatically update, as the influence processing, the setting content of another setting item determined to be influenced. In the example of FIG. 13, the influence processing execution module 108 may delete the setting content for a user U5 from the setting item “access right” determined to be influenced. It is assumed that the processing content for the another setting item determined to be influenced is determined in advance. The influence processing execution module 108 is only required to execute the processing determined in advance for the another setting item.

The display control system 1 according to Modification Example 4 determines, based on the relationship data indicating the relationship between the setting items of the app setting data, whether or not a setting item influenced by the update of the app setting data exists. The display control system 1 executes the influence processing based on a result of the determination of whether or not a setting item to be influence exists, thereby being capable of further increasing the convenience of the user. For example, the display control system 1 causes the user terminal 20 to display the influence screen SC7, thereby being capable of prompting the user to review the another setting item. For example, the display control system 1 automatically updates the setting content of the another setting item, thereby being capable of eliminating necessity for an update operation for the another setting item by the user.

### 5-5. Modification Example 5

For example, after the user executes the update operation, the user may execute at least one of an UNDO operation which achieves a state before the execution of the update operation or a REDO operation which again achieves a state after the update operation. In the example of FIG. 3, an operation of selecting a button B34 by the user corresponds to the UNDO operation. An operation of selecting a button B35 by the user corresponds to the REDO operation. Each of the UNDO operation and the REDO operation may be another operation such as pressing of a predetermined button of a keyboard included in the operating unit 24 by the user. It is assumed that the execution of at least one of the UNDO operation or the REDO operation by the user is indicated in operation data received by the server 10 from the user terminal 20. The server 10 can identify, based on the operation data, that the user has executed at least one of the UNDO operation or the REDO operation.

The saving module 102 in Modification Example 5 saves, when the user has executed at least one of the UNDO operation or the REDO operation after the execution of the update operation, in the data storage module 100, the update location data indicating that the at least one operation has been executed. That is, the saving module 102 saves, as one history of a series of the update operations by the user, the at least one of the UNDO operation or the REDO operation in the update location data. The display control module 103 displays the execution of the at least one operation on the update location screen SC4.

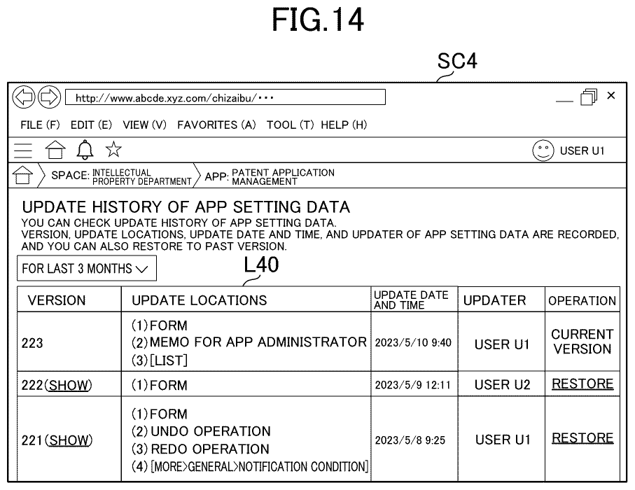

FIG. 14 is a view for illustrating an example of the update location screen SC4 in Modification Example 5. In the example of FIG. 14, the user has executed the UNDO operation and the REDO operation when the user updates the app setting data to the version 221. For example, the display control module 103 displays the execution of each of the UNDO operation and the REDO operation in a field of the update locations on the update location screen SC4. When the user executes only the UNDO operation without executing the REDO operation, the display control module 103 displays the execution of the UNDO operation in the field of the update locations of the update location screen SC4.

The display control module 103 can display the execution of at least one of the UNDO operation or the REDO operation on the update location screen SC4 by any display method. The display control module 103 may display an icon indicating the execution of the UNDO operation and an icon indicating the execution of the REDO operation on the update location screen SC4 in addition to the display method of using such character strings as those of FIG. 14.

The display control system 1 in Modification Example 5 saves, when the user has executed at least one of the UNDO operation or the REDO operation on the setting update screen SC3, in the data storage module 100, the update location data indicating that the at least one operation has been executed. The display control system 1 displays the execution of the at least one operation on the update location screen SC4. With the update location screen SC4, identification of the setting item which the user has hesitated to set is promoted, and hence the display control system 1 can further increase the convenience of the user.

### 5-6. Modification Example 6

For example, the display control system 1 may simultaneously receive the update operations from a plurality of setting update screens SC3. In Modification Example 6, it is assumed that each of a user U1 and a user U2 opens the setting update screen SC3 for the same app on his or her own user terminal 20. In this case, the user U2 may complete the update of the app setting data before the user U1 completes the update of the app setting data. In Modification Example 6, in this case, a message prompting the user U1 to reload the setting update screen SC3 is displayed on the setting update screen SC3 of the user U1.

The display control system 1 includes the simultaneous update determination module 109 and the simultaneous update processing execution module 110. The simultaneous update determination module 109 determines whether or not the app setting data is to be simultaneously updated from a plurality of setting update screens SC3. The plurality of setting update screens SC3 may be displayed on the user terminals 20 of users different from each other, or may be displayed on the user terminal 20 of the same user. For example, the plurality of setting update screens SC3 may be displayed on different windows or tabs of the user terminal 20 of a certain user.

For example, the simultaneous update determination module 109 determines whether or not display requests for the setting update screen SC3 of the same app have been received from a plurality of user terminals 20, to thereby determine whether or not the app setting data is to be simultaneously updated from the plurality of setting update screens SC3. In Modification Example 6, the simultaneous update determination module 109 determines whether or not the display requests for the setting update screen SC3 of the same app have been received from the user terminals 20 of the users U1 and U2.

For example, before the user U1 completes the update of the app setting data for a certain app, when the display request for the setting update screen SC3 of the same app is received from the user terminal 20 of the user U2, the simultaneous update determination module 109 determines that the app setting data is to be simultaneously updated from the plurality of the setting update screens SC3. Before the user U2 completes the update of the app setting data for a certain app, when the display request for the setting update screen SC3 of the same app is received from the user terminal 20 of the user U1, the simultaneous update determination module 109 determines that the app setting data is to be simultaneously updated from the plurality of the setting update screens SC3.

The simultaneous update processing execution module 110 executes predetermined simultaneous update processing based on a determination result obtained by the simultaneous update determination module 109. The simultaneous update processing is processing executed when it is determined that the app setting data is to be simultaneously updated from a plurality of setting update screens SC3. In Modification Example 6, the simultaneous update processing execution module 110 displays the message which prompts the user to reload the setting update screen SC3 on the setting update screen SC3, to thereby execute the simultaneous update processing. It is assumed that the user terminal 20 periodically communicates to and from the server 10, to thereby check whether or not it is required to reload the setting update screen SC3.

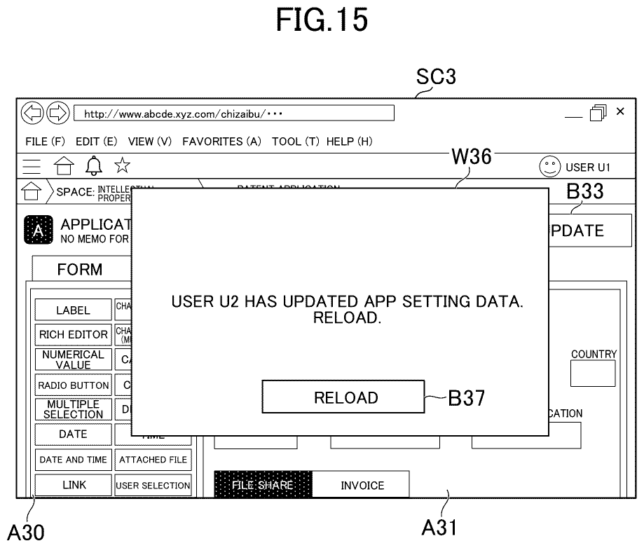

FIG. 15 is a view for illustrating an example of the setting update screen SC3 at the time when the simultaneous update processing is executed. As illustrated in FIG. 15, when it is determined that the app setting data is to be simultaneously updated from the plurality of setting update screens SC3, the simultaneous update processing execution module 110 displays a window W36 which indicates a message for reloading the setting update screens SC3 on the setting update screen SC3, to thereby execute the simultaneous update processing. When the user selects a button B37, the user terminal 20 reloads the setting update screen SC3 between the user terminal 20 and the server 10. In the example of FIG. 15, the window W36 indicates not only the message for reloading the setting update screen SC3, but also a name of the user U2 who has updated the app setting data of the same app.

The simultaneous update processing may be other processing. For example, when the setting item of the update operation executed by the user U1 and the setting item of the update operation executed by the user U2 do not overlap each other, the simultaneous update processing execution module 110 may execute, as the simultaneous update processing, processing of automatically reflecting the setting content of the setting item of the update operation executed by the user U2 in the setting update screen SC3 of the user U1. For example, the simultaneous update processing execution module 110 may execute, as the simultaneous update processing, processing of displaying the setting item of the update processing executed by the user U2 on the setting update screen SC3 of the user U1 such that this setting item is distinguished from the other setting items.

Moreover, a situation similar to the case in which a plurality of users simultaneously open the setting update screens SC3 may occur also when one certain user simultaneously opens the setting update screen SC3 in a plurality of windows or in a plurality of tabs. That is, one certain user sometimes simultaneously executes the update operation from the plurality of windows or the plurality of tabs. Also in this case, the simultaneous update determination module 109 and the simultaneous update processing execution module 110 may execute processing similar to that described above.

The display control system 1 according to Modification Example 6 determines whether or not the app setting data is to be simultaneously updated from a plurality of setting update screens SC3. The display control system 1 executes the simultaneous update processing based on the determination result obtained by the simultaneous update determination module 109, and hence can further increase the convenience of the user. For example, the display control system 1 can display the window W36 on the setting update screen SC3 to prompt the user U1 to reload the setting update screen SC3. An update operation before reloading the setting update screen SC3 is discarded, but a subsequent update operation is effective. Thus, the display control system 1 can prevent the update processing of the user U1 from becoming wasted.

### 5-7. Modification Example 7

For example, the user sometimes requests a third party different from an organization to which the user himself or herself belongs to examine the app setting data. The third party may be an individual or an organization. The third party receives the request from the user to examine the app setting data. The third party may be a user of the groupware, but in Modification Example 7, it is assumed that the third party does not log in to the groupware and uses an electronic mail or the like to report an examination result of the app setting data. In this case, the display control system 1 may provide the update locations of the app setting data to the third party.

The display control system 1 according to Modification Example 7 includes the provision module 111. The provision module 111 provides, based on third-party attribute data indicating an attribute of a third party different from the organization to which the user belongs, data for third party indicating the update location for the third party to the third party. The data storage module 100 in Modification Example 7 stores the third-party attribute data. The third-party attribute data may be stored in a computer other than the server 10 or in an external information storage medium. The attribute is information for the server 10 to classify the third party. For example, the attribute is a role or a business type of the third party.

For example, when the third party is a company responsible for security, and is responsible for the setting item “access right” of the app setting data, the provision module 111 provides the update location of the setting item “access right” to the third party. When the third party is a designer responsible for the setting item “form” of the app setting data, the provision module 111 provides the update location of the setting item “form” to the third party. It is assumed that a relationship between a setting item provided to a third party and an attribute of this third party is defined in the third-party attribute data. The provision module 111 provides the update location to the third party based on the definition indicated by the third-party attribute data.

The display control system 1 according to Modification Example 7 can provide, based on the third-party attribute data indicating the attribute of the third party different from the organization to which the user belongs, the data for third party to this third party, thereby being capable of providing optimal information to the third party. For example, it is possible to prevent leakage to the company responsible for the security of the setting content of the setting item “form,” which is unnecessary for this company. For example, it is possible to prevent leakage to the designer of the setting content of the setting item “access right,” which is unnecessary for this designer.

### 5-8. Modification Example 8

For example, the app may cooperate, through an API, with another app, a program in the server 10, or another computer other than the server 10. In this case, when the app setting data is updated, the update may influence the another computer or the program which cooperates with the app through the API. Thus, the display control system 1 according to Modification Example 8 notifies the user of a range that may be influenced.

The display control system 1 includes the identification module 112 and the range processing execution module 113. The identification module 112 identifies, when the app setting data is updated, a range influenced by the update of the app setting data based on API cooperation data indicating an API cooperating with the app. The data storage module 100 in Modification Example 8 stores the API cooperation data. The API cooperation data may be in any form, and may be, for example, in a table form, a part of a program, in a mathematical expression form, or a model of machine learning.

For example, the API cooperation data may be prepared by the provider of the groupware, or may be prepared by the user. In the API cooperation data, another app, a program in the server 10, or another computer other than the server 10 with which the app cooperates through the API are indicated. In Modification Example 8, it is assumed that the app “patent application management,” the another app “pension management,” and another piece of groupware XXX cooperate with one another through an API. In this case, it is assumed that the API cooperation among the app “patent application management,” the another app “pension management,” and another piece of groupware XXX is indicated in the API cooperation data.

The range processing execution module 113 executes predetermined range processing based on the range. It is only required that the range processing be certain processing relating to the range influenced by the update of the app setting data. In Modification Example 8, processing of prompting the user to review setting of the another app, the program in the server 10, and the another computer other than the server 10 influenced by the update of the app setting data corresponds to the range processing. For example, the range processing execution module 113 causes the user terminal 20 to display a range screen which prompts the user to review the range when the app setting data for the app “patent application management” is updated.

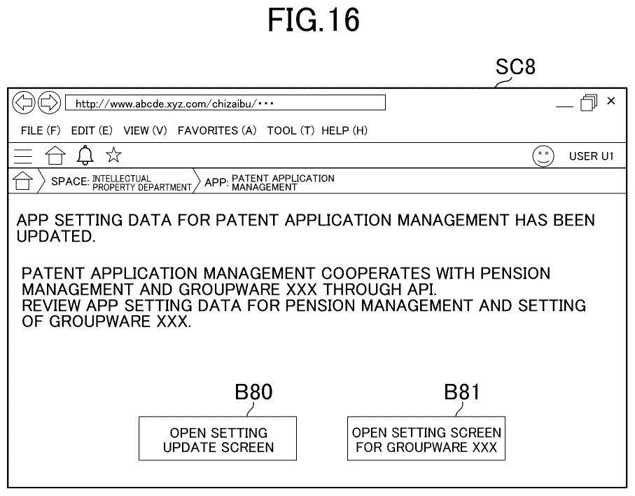

FIG. 16 is a view for illustrating an example of the range screen. For example, the range processing execution module 113 causes the user terminal 20 to display a range screen SC8 including such a message as “Review app setting data for pension management and setting of groupware XXX.” when the app setting data for the app “patent application management” is updated. The range processing execution module 113 transmits display data on the range screen SC8 to the user terminal 20, to thereby cause the user terminal 20 to display the range screen SC8.

For example, when the user selects a button B80 of the range screen SC8, the display control module 103 causes the user terminal 20 to display the setting update screen SC3 for the another app “pension management.” When the user selects a button B81 of the range screen SC8, the display control module 103 causes the user terminal 20 to display a screen for the user to log in to the another piece of groupware XXX. When the user logs in to the another piece of groupware XXX, the server 10 or another server computer causes the user terminal 20 to display a setting screen indicating setting of the another piece of groupware XXX.

The range processing may be other processing. For example, the range processing execution module 113 may automatically update setting content in the influenced range as the range processing. In the example of FIG. 16, the range processing execution module 113 may update the app setting data for the another app “pension management” based on the update location of the app setting data for the app “patent application management,” to thereby execute the range processing. The range processing execution module 113 may automatically update the setting of the another piece of groupware XXX based on the update location of the app setting data for the app “patent application management,” to thereby execute the range processing.

The display control system 1 according to Modification Example 8 identifies, when the app setting data is updated, a range influenced by the update of the app setting data based on the API cooperation data indicating the API cooperating with the app. The display control system 1 executes the predetermined range processing based on the identified range, thereby being capable of further increasing the convenience of the user. For example, the display control system 1 causes the user terminal 20 to display the range screen SC8, thereby being capable of prompting the user to review the setting content of the another app or the like. The display control system 1 automatically updates the setting content of the another app or the like, thereby being capable of eliminating necessity for the update operation for the another app or the like by the user.

### 5-9. Other Modification Examples

For example, the display control system 1 may combine Modification Example 1 to Modification Example 8. The display control system 1 may not include the functions described in the at least one embodiment, and may include the functions in at least one of Modification Example 1 to Modification Example 8. That is, the display control system 1 may not include the saving module 102, the display control module 103, and the restoration module 104, and may include the function in at least one of Modification Example 1 to Modification Example 8. The present disclosure includes the configuration which solve the plurality of problems. Thus, the display control system 1 may not include the configuration which solves the problems described in the at least one embodiment, and may include only the configuration which solves another problem.

For example, when the display control system 1 includes the restoration module 104, the display control system 1 may not include the function (some of the functions of the display control module 103) of causing the user terminal 20 to display the update location screen SC4. That is, the display control system 1 may restore the app setting data without causing the user terminal 20 to display the update location screen SC4. The app is only required to be used in the groupware, and may not be a type of database. That is, the app may not have the function as the database, but may have only other functions. In this case, the app may not include the database, and may be formed of only the program.

For example, the functions described as being implemented by the server 10 may be implemented by the user terminal 20. In this case, it is only required that the functions similar to those of the server 10 be implemented by a script of the browser executing the functions, or by a program installed in the user terminal 20 executing the functions. The functions described as being implemented by the server 10 may be distributed to a plurality of computers.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A display control system, comprising at least one processor configured to:
update, based on an update operation executed by a user who uses groupware, app setting data indicating a setting of an app of the groupware;
save, in a data storage module, update location data indicating an update location of the app setting data when the app setting data is updated; and
display, based on the update location data, the update location on an update location screen of the groupware.

2. The display control system according to claim 1,
wherein when the app setting data includes a plurality of the update locations, the update location data indicates a chronological relationship among the plurality of the update locations, and
wherein the at least one processor is configured to display the plurality of the update locations arranged in a chronological order on the update location screen.

3. The display control system according to claim 1, wherein the at least one processor is configured to restore the app setting data based on a restoration operation executed on the update location screen by the user.

4. The display control system according to claim 3, wherein the at least one processor is configured to restore the app setting data such that at least one of change, cancel, or addition of the update location is executed on past app setting data.

5. The display control system according to claim 3, wherein the at least one processor is configured to restore, when past app setting data includes a plurality of the update locations, the app setting data based on setting content at a time corresponding to an update location that is selected by the user among the plurality of the update locations.

6. The display control system according to claim 3, wherein the at least one processor is configured to:
reuse the app setting data for another app different from the app; and
execute predetermined another-app processing when the app setting data for the app that has been reused for the another app has been restored.

7. The display control system according to claim 1, wherein the at least one processor is configured to:
determine, based on relationship data indicating a relationship between setting items of the app setting data, whether a setting item influenced by the update of the app setting data exists; and
execute predetermined influence processing based on a result of the determination.

8. The display control system according to claim 1, wherein the at least one processor is configured to:
save, when the user executes at least one of an UNDO operation or a REDO operation after the execution of the update operation, in the data storage module, the update location data indicating that the at least one of the UNDO operation or the REDO operation has been executed; and
display the execution of the at least one of the UNDO operation or the REDO operation on the update location screen.

9. The display control system according to claim 1,
wherein the update operation is executed on a setting update screen of the groupware, and
wherein the at least one processor is configured to:
determine whether the app setting data is to be simultaneously updated from a plurality of the setting update screens; and
execute predetermined simultaneous update processing based on a result of the determination.

10. The display control system according to claim 1, wherein the at least one processor is configured to provide, based on third-party attribute data indicating an attribute of a third party different from an organization to which the user belongs, data for third party indicating the update location for the third party to the third party.

11. The display control system according to claim 1, wherein the at least one processor is configured to:
identify, when the app setting data has been updated, a range influenced by the update of the app setting data based on API cooperation data indicating an API cooperating with the app; and
execute predetermined range processing based on the range.

12. A display control method, comprising:
updating, based on an update operation executed by a user who uses groupware, app setting data indicating a setting of an app of the groupware;
saving, in a data storage module, update location data indicating an update location of the app setting data when the app setting data is updated; and
displaying, based on the update location data, the update location on an update location screen of the groupware.

13. A non-transitory information storage medium having stored thereon a program for causing a computer to:
update, based on an update operation executed by a user who uses groupware, app setting data indicating a setting of an app of the groupware;
save, in a data storage module, update location data indicating an update location of the app setting data when the app setting data is updated; and
display, based on the update location data, the update location on an update location screen of the groupware.
